(19) United States
(12) Patent Application Publication
(10) Pub. No.: US 2012/0160280 A1
(43) Pub. Date: Jun. 28, 2012

(54) CLEANING DEVICE

(75) Inventor: Young Man KWON, Beijing (CN)

(73) Assignee: BEIJING BOE OPTOELECTRONICS TECHNOLOGY CO., LTD., Beijing (CN)

(21) Appl. No.: 13/337,440

(22) Filed: Dec. 27, 2011

(30) Foreign Application Priority Data
Dec. 28, 2010 (CN) 201010611765.0

(51) Int. Cl. B08B 3/00

(52) U.S. Cl. 134/110

(57) ABSTRACT

Embodiments of the disclosed technology provide a cleaning device comprising a cleaning tank and a filter system, wherein, an overflow port is provided at the top of the cleaning tank, liquid in the cleaning tank can overflow through the overflow port toward an inlet of the filter system, and then flow back into the cleaning tank via an outlet of the filter system.

### BACKGROUND

Embodiments of the disclosed technology relates to a cleaning device.

As the term suggests, cleaning devices are used for cleaning other objects or devices. There are various cleaning devices, such as a cleaning device having only one cleaning tank in which the cleaning liquid is provided for soaking and cleaning, or an ultrasonic cleaning unit with one cleaning tank on walls of which a generator and an energy transducer are provided. Hereinafter, an ultrasonic cleaning unit is taken as an example for describing the related arts.

It is well known that ultrasonic wave is inaudible for human ears. Due to its high frequency and short wavelength and hence its good propagating orientation and strong penetration, it is used in designing an ultrasonic cleaning unit. The principle for the ultrasonic cleaning unit is in that a transducer, which converts acoustic energy into mechanical vibration, radiates ultrasonic waves onto the cleaning liquid in a tank through the wall thereof. Under the ultrasonic wave, micro-bubbles in the liquid in the tank keep vibrating and thus cleaning is performed.

By referring to FIG. 1, the configuration of a conventional ultrasonic cleaning unit is described as follows.

The ultrasonic cleaning unit comprises a cube cleaning tank 1. Cleaning liquid, e.g., de-ionized water, is placed in the cleaning tank 1. A generator 2 and an energy transducer 3 are provided on the side wall or the bottom wall of the cleaning tank. The generator 2 creates a signal with high-frequency and high pressure and transmits it to the energy transducer 3 through a coupling cable, and then the energy transducer 3, together with a vibrating plate, produces high-frequency resonance. A first drainage pipe 4 and a fourth drainage pipe 5 are provided on the side walls of the cleaning tank 1, and an outlet of the first drainage pipe 4 is communicated with a pump 7. An outlet of the pump 7 is communicated with the second drainage pipe 11, and an outlet of the second drainage pipe 11 is communicated with a filter 8. An outlet of the filter 8 is communicated with the third drainage pipe 12, and the third drainage pipe 12 is communicated with an external liquid delivery pipe 6 and further communicated with the cleaning tank 1 through the liquid delivery pipe 6. Thus, a circle passage for the cleaning liquid is formed. One end of the fourth drainage pipe 5 is communicated with the cleaning tank I, while the other end is communicated with the outside, and a drain valve 9 is provided on the fourth drainage pipe 5.

When such an ultrasonic cleaning unit is used, the cleaning tank is connected with an external liquid delivery pipe which delivers cleaning liquid into the cleaning tank. After the cleaning tank is filled with the cleaning liquid, the objects to be cleaned, e.g., a framework 10 of a backlight source, is placed into the cleaning tank. Some of the contaminations on the framework will be removed after the framework is kept for a certain period in the cleaning liquid. The contamination particles with relatively larger surface will ascent up to the water surface due to surface tension and buoyancy force. On the contrary, the contamination particles with relatively smaller surface will fall onto the bottom inside the cleaning tank. Thereafter, where ultrasonic wave is applied, the contamination particles swing intensively and wander across the whole inner space of the cleaning tank due to the vortex. When the framework is extracted out of the cleaning liquid finally, many contamination particles will again adhere to the surface of the framework, resulting in an obviously poor cleaning effect. Although the contaminations at the bottom inside the cleaning tank can be filtered through the filter, the contaminations floating over the water surface is difficult to be removed. Therefore, the cleaning liquid has to be drained through the fourth drainage pipe after being used for several times due to excessive contaminations therein, which decreases the utilization rate of the cleaning liquid.

### SUMMARY

An embodiment of the disclosed technology provides a cleaning device comprising a cleaning tank and a filter system, wherein, an overflow port is provided at the top of the cleaning tank, liquid in the cleaning tank can overflow through the overflow port toward an inlet of the filter system, and then flow back into the cleaning tank via an outlet of the filter system.

Another embodiment of the disclosed technology provides a cleaning device comprising a cleaning tank and a filter system, wherein, the cleaning tank has a funnel-shaped bottom, and an outlet is provided at the tip of the funnel-shaped bottom; and liquid in the cleaning tank can flow via the outlet at the bottom of the cleaning tank toward the inlet of the filter system and flow back into the cleaning tank via the outlet of the filter system.

Further scope of applicability of the disclosed technology will become apparent from the detailed description given hereinafter. However, it should be understood that the detailed description and specific examples, while indicating preferred embodiments of the disclosed technology, are given by way of illustration only, since various changes and modifications within the spirit and scope of the disclosed technology will become apparent to those skilled in the art from the following detailed description.

### BRIEF DESCRIPTION OF THE DRAWINGS

The disclosed technology will become more fully understood from the detailed description given hereinafter and the accompanying drawings which are given by way of illustration only, and thus are not limitative of the disclosed technology and wherein:

FIG. 1 is a structural schematic view of an ultrasonic cleaning unit in the related art;

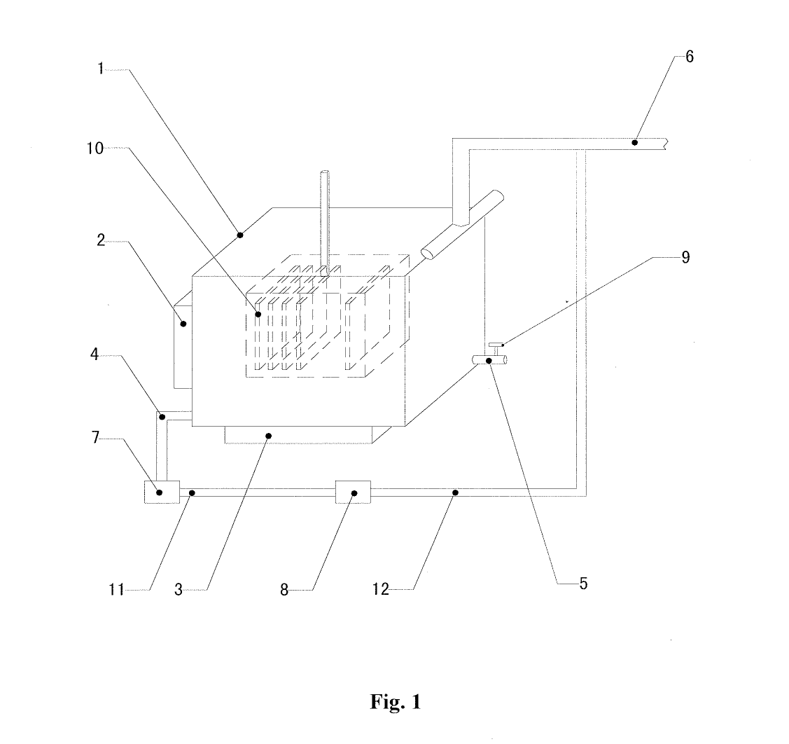

FIG. 2 is a structural schematic view of a cleaning device according to a first embodiment of the disclosed technology;

FIG. 3 is a structural schematic view of a cleaning device according to a second embodiment of the disclosed technology;

FIG. 4 is a structural schematic view of a cleaning device according to an embodiment of the disclosed technology;

FIG. 5 is a structural schematic view showing a design for an overflow port of a cleaning device according to an embodiment of the disclosed technology; and

FIG. 6 is a cross-sectional view showing a design for an overflow port of a cleaning device according to en embodiment of the disclosed technology.

### DETAILED DESCRIPTION

Embodiments of the disclosed technology now will be described more clearly and fully hereinafter with reference to the accompanying drawings, in which the embodiments of the disclosed technology are shown. Apparently, only some embodiments of the disclosed technology, but not all of embodiments, are set forth here, and the disclosed technology may be embodied in other forms. All of other embodiments made by those skilled in the art based on embodiments disclosed herein without mental work fall within the scope of the disclosed technology.

Embodiments of the disclosed technology provide a cleaning device comprising a cleaning tank and a filter system. The connection between the filter system and the cleaning tank can employ one or both of the following arrangements.

First, liquid overflowing through an overflow port at the top of the cleaning tank flows toward an inlet of the filter system and then into the cleaning tank via an outlet of the filter system.

Second, the cleaning tank has a funnel-shaped bottom and is provided with an outlet at the tip of the funnel-shaped bottom. Liquid flowing from the bottom outlet of the cleaning tank flows to the inlet of the filter system and into the cleaning tank via the outlet of the filter system.

### First Embodiment

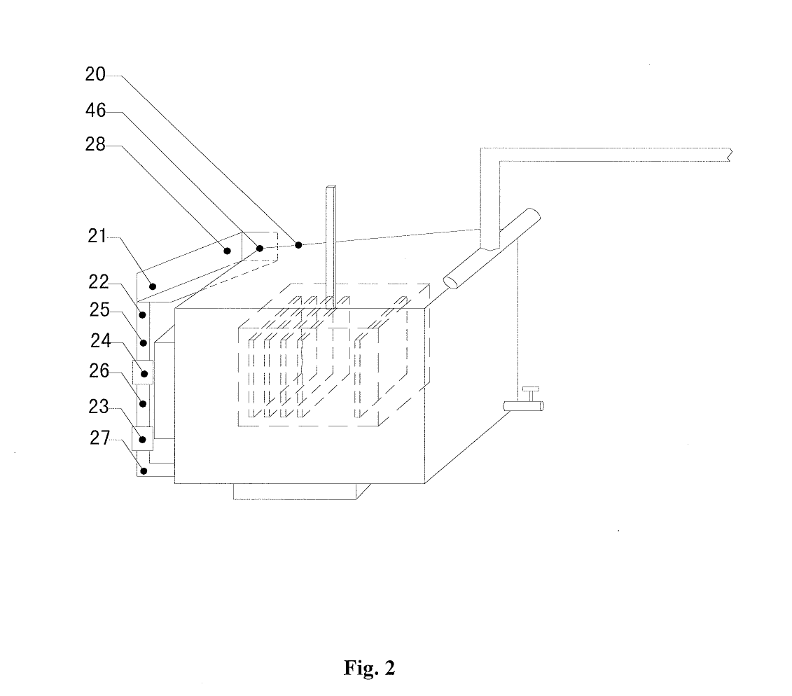

The embodiment in which the filter system and the cleaning tank are connected with the first arrangement as mentioned above is described in detail hereinafter. As shown in FIG. 2, the filter system in a cleaning device according to the embodiment of the disclosed technology comprises a receiving tank 28, a first pipeline assembly 22, a first filter 23 and a first pump 24. In the embodiment of the disclosed technology, an overflow port is provided at the top of the cleaning tank, and the receiving tank 28 of the filter system is located at the overflow port at the top of the cleaning tank 20 and receives liquid overflowing through the overflow port. In order to reuse the liquid overflowing through the overflow port, the outlet of the receiving tank 28 is communicated with the cleaning tank 20 through the first pipeline assembly 22 in the embodiment of the disclosed technology, and the first filter 23 and the first pump 24 are provided at the midway of the first pipeline assembly 22. Thus, the number of contamination particles with relatively larger surface (i.e., those particles at the top surface of the cleaning liquid) in the cleaning tank 20 is decreased after the liquid overflowing through the overflow port is filtered through the filter system 21. As such, when the objects to be cleaned is extracted out of the cleaning liquid after being cleaned, the number of the contamination particles adhering thereon is decreased, resulting in an improved cleaning effect. In addition, as the contaminations in the upper part of the cleaning liquid are filtered, the cleaning liquid can be used for longer time, and the utilization rate of cleaning liquid is increased accordingly.

The specific arrangement in which the first pipeline assembly and the cleaning tank are communicated in the embodiment of the disclosed technology is not particularly limited. For example, they can be communicated with each other as follows. The first pipeline assembly 22 comprises a first connecting pipe 25, a second connecting pipe 26 and a third connecting pipe 27. In the embodiment of the disclosed technology, an outlet of the receiving tank is communicated with an inlet of the first pump 24 through the first connecting pipe 25, an outlet of the first pump 24 is communicated with an inlet of the first filter 23 through the second connecting pipe 26, an outlet of the first filter 23 is communicated with the cleaning tank 20 through the third connecting pipe 27. Thus, a cycle passage for filtering the cleaning liquid is created: the contamination particles with larger surface (i.e., those particles located at the top surface of the cleaning liquid) in the cleaning tank run into the receiving tank 28 with the liquid overflowing through the overflow port, the liquid is then pumped into the second connecting pipe 26 through the first pump 24 and then into the first filter 23 to be filtered, and the filtered liquid again flows back into the cleaning tank 20 through the third connecting pipe 27 so as to complete a filtering circulation.

The design for the overflow port according to the embodiment of the disclosed technology is not particularly limited, as long as it is located at the top of the cleaning tank so that the upper part of the cleaning liquid in which the contamination particle with relative larger surface accumulate can overflow through the overflow port. For example, the following arrangements for the overflow port can be employed.

First, as shown in FIG. 2, the overflow port 46 is located at one corner of the top of the cleaning tank 20 which is lower than the other parts of the top edge of the cleaning tank 20. In this way, the cleaning liquid can overflow once the liquid surface of it exceeds above the overflow port. The receiving tank 28 for receiving the overflowing cleaning liquid is arranged right below the overflow port, and guides the liquid into the filter system for filtering.

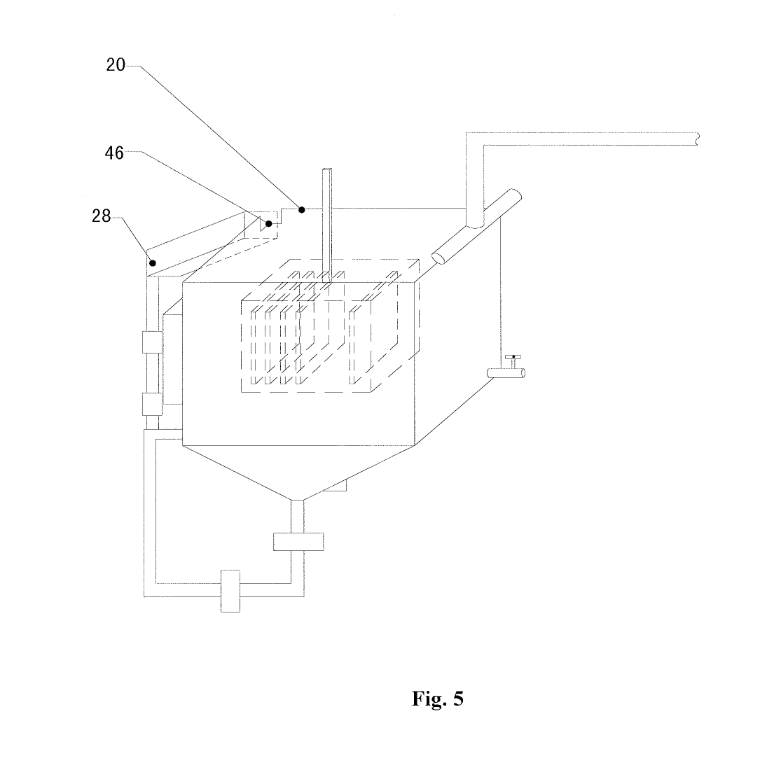

Second, as shown in FIG. 5, the overflow port 46 is arranged as a notch at one corner of the top of the cleaning tank, the operation principle of which is the same as that of the example in FIG. 2.

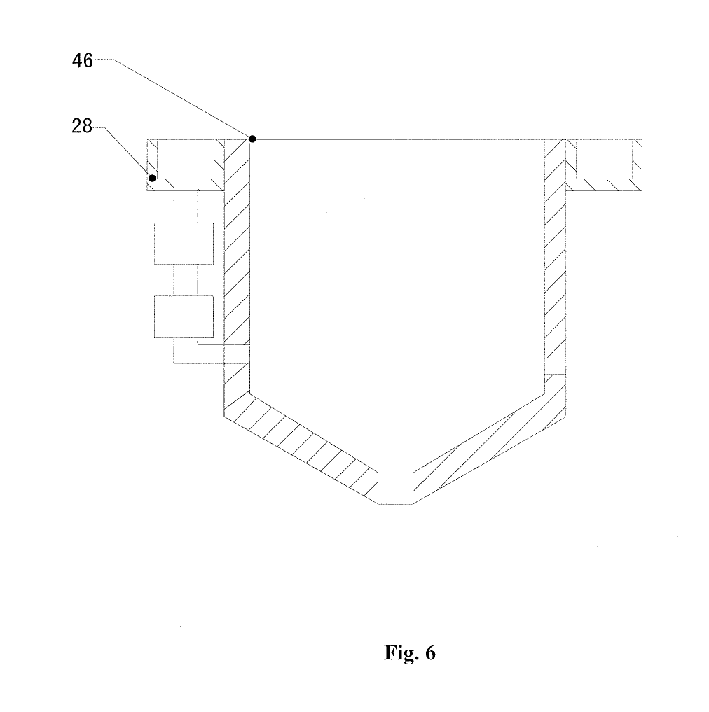

Third, as shown in FIG. 6, the whole of the top opening of the cleaning tank is used as an overflow port 46, and a receiving tank 28 surrounds the outer periphery of the cleaning tank and is located below the overflow port. It is necessary for the receiving tank 28 to have an entire circle around the cleaning tank. In this way, the overflowing cleaning liquid from the overflow port falls directly into the receiving tank and flows into the filter system for filtering.

### Second Embodiment

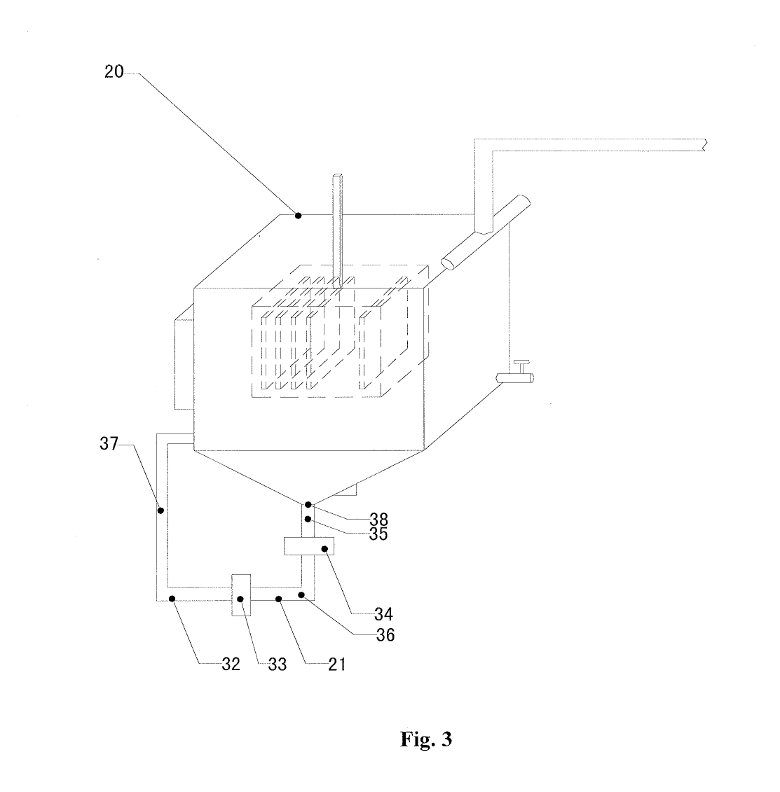

The embodiment in which the filter system and the cleaning tank are connected with the second arrangement as mentioned above is described in detail hereinafter. As shown in FIG. 3, the filter system in a cleaning device according to the embodiment of the disclosed technology comprises a second pipeline assembly 32, a second filter 33 and a second pump 34. In this embodiment of the disclosed technology, the cleaning tank has a funnel-shaped bottom and an outlet 38 is provided at the tip of the funnel-shaped bottom. In order to reuse the liquid drained from the bottom outlet of the cleaning tank, the outlet 38 is communicated with the cleaning tank 20 through the second pipeline assembly 32, and the second filter 33 and the second pump 34 are provided at the midway of the second pipeline assembly 32, thus creating a cycle passage for filtering the cleaning liquid. Thus, the number of the contamination particles with smaller surface (i.e., those particles falling down to the bottom of the cleaning liquid) is decreased after the liquid drained from the bottom outlet 38 of the cleaning tank is filtered through the filter system. As such, since the contamination particles with smaller surface would accumulate at the outlet at the tip of the bottom of the cleaning tank, they can run out with the drained liquid and be filtered. The number of the contamination particles in the cleaning liquid is decreased, resulting in an improvement of the cleaning effect and the utilization rate for the cleaning liquid.

The specific arrangement in which the second pipeline assembly and the cleaning tank are communicated in the embodiment of the disclosed technology is not particularly limited. For example, they can be communicated with each other as follows. The second pipeline assembly 32 comprises a fourth connecting pipe 35, a fifth connecting pipe 36 and a sixth connecting pipe 37. An inlet of the second pump 34 is communicated with the bottom outlet 38 of the cleaning tank through the fourth connecting pipe 35, an outlet of the second pump 34 is communicated with the second filter 33 through the fifth connecting pipe 36, an outlet of the second filter 33 is communicated with the cleaning tank 20 through the sixth connecting pipe 37, thus a cycle passage for filtering the cleaning liquid is created. The contamination particles with smaller surface in the cleaning tank will accumulate at the outlet 38 at the bottom tip of the cleaning tank, the liquid is then pumped into the fifth connecting pipe 36 through the second pump 34 and then into the second filter 33 for filtering, and the filtered liquid flows back into the cleaning tank through the sixth connecting pipe 37 so as to complete the filtering circulation.

Both of the two arrangements for the connection between the filter system and the cleaning tank as shown in FIGS. 2 and 3 can be applied simultaneously in a cleaning device according to an embodiment of the disclosed technology. That is to say, the filter system for the top overflow port and the filter system for the bottom outlet can be designed in one cleaning device. Thus, it is possible to simultaneously filter the contaminations in the cleaning liquid at the top and the bottom of cleaning tank, which improves the filtration effect and increase the utilization rate of the cleaning liquid.

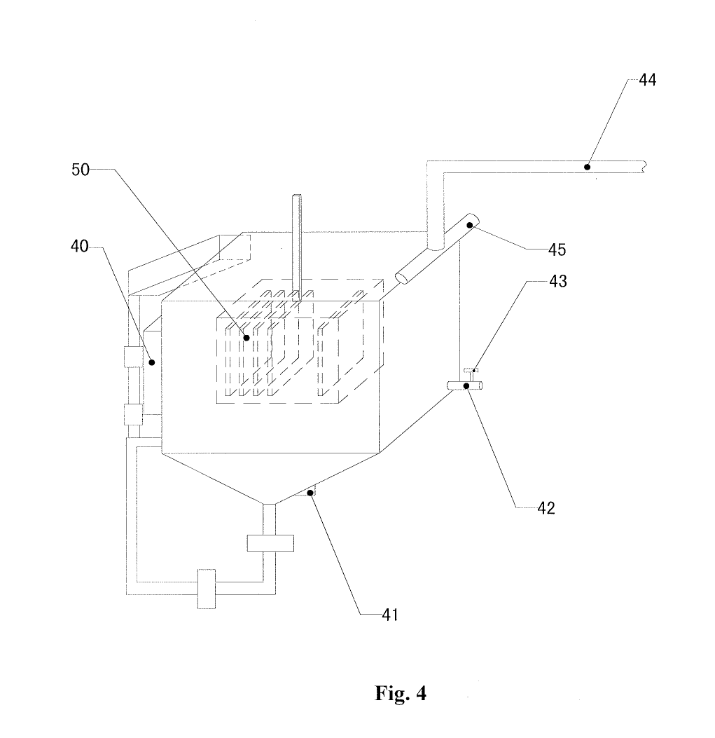

The filter system according to the embodiments described above can be applied in an ultrasonic cleaning unit but is not limited thereto. For example, as described in FIG. 4, a generator 40 is threaded onto an outside wall of the cleaning tank and an energy transducer 41 is threaded onto a bottom wall. The generator creates a signal with high-frequency and high pressure and transmits it to the energy transducer through a coupling cable so that the energy transducer, together with a vibrating plate, produces high-frequency resonance. In this way, it is possible to clean not only normal objections but also special objections or devices.

In the embodiments of the disclosed technology, in order to facilitate the drainage of the cleaning liquid in the cleaning tank when the cleaning liquid is not qualified, a drainage pipe 42 can be provided on the side wall or the bottom wall of the cleaning tank, and a control valve 43 is provided on the drainage pipe 42. In this way, the cleaning liquid can be drained from the drainage pipe 42 if necessary.

In the embodiments of the disclosed technology, to facilitate the cleaning liquid to be added into the cleaning tank, a liquid delivery pipe 44 may be further provided and the liquid from an outlet of the liquid delivery pipe 44 can flow into the cleaning tank 20, such that it is not necessary to add cleaning liquid by pouring into the cleaning tank manually.

In the embodiments of the disclosed technology, in order to facilitate the contaminations at the top of the cleaning liquid in the cleaning tank to be drained into the receiving tank with the cleaning liquid, a liquid delivery branch 45 is further provided. The liquid delivery branch 45 is communicated with an outlet of the liquid delivery pipe 44, and the wall of the liquid delivery branch 45 is closely against the top of the inner wall of the cleaning tank 20. The liquid from the outlet of the liquid delivery pipe can flow into the cleaning tank via delivery ports of the liquid delivery branch. The liquid delivery branch may be arranged horizontally so that the cleaning liquid entering into the cleaning tank through the liquid delivery branch can flow horizontally, which suppresses turbulence of the cleaning liquid in the cleaning tank and facilitates the contaminations at the top of the cleaning liquid in the cleaning tank to flow into the receiving tank with the cleaning liquid.

The embodiments of the disclosed technology may apply to cleaning apparatus for cleaning any objections, for example, a cleaning apparatus for cleaning a backlight framework of a liquid crystal display (LCD) device.

The operation of the cleaning device according to the embodiments of the disclosed technology is described as follows with an example in which a backlight framework of a LCD device is cleaned. Firstly, cleaning liquid, e.g., de-ionized water, is delivered into the cleaning tank through the liquid delivery pipe 44; then a framework 50 is placed into the de-ionized water. When the framework 50 is dipped in the de-ionized water, some contamination particles with larger surface will ascent up to the surface of the de-ionized water, while some contamination particles with smaller surface will fall onto the drainage port 38 at the tip of the bottom of the cleaning tank. Then the first pump 24 and the second pump 34 pump the liquid with contaminations into the first filter 23 and the second pump 33 for the filtering process. Thereafter, the generator 40 and the energy transducer 41 are turned on to perform ultrasonic cleaning, and the filtering process is continued by the first filter 23 and the first filter 33. Finally, the framework 50 is extracted out of the cleaning liquid.

It should be noted that the above embodiments only have the purpose of illustrating the disclosed technology, but not limiting it. Although the disclosed technology has been described with reference to the above embodiment, those skilled in the art should understand that modifications or alternations can be made to the solution or the technical feature in the described embodiments without departing from the spirit and scope of the disclosed technology.

What is claimed is:

1. A cleaning device comprising a cleaning tank and a filter system,
wherein an overflow port is provided at the top of the cleaning tank, liquid in the cleaning tank can overflow through the overflow port toward an inlet of the filter system, and then flow back into the cleaning tank via an outlet of the filter system.

2. The cleaning device of claim 1, wherein,
the cleaning tank comprises a funnel-shaped bottom, and an outlet is provided at a tip of the funnel-shaped bottom; and
liquid in the cleaning tank can flow via the outlet at the bottom of the cleaning tank toward the inlet of the filter system and flow back into the cleaning tank via the outlet of the filter system.

3. The cleaning device of claim 1, wherein,
the filter system includes a receiving tank, a first pipeline assembly, a first filter, and a first pump;
the receiving tank is located at the overflow port at the top of the cleaning tank and used for receiving the liquid overflowing the overflow port; and
an outlet of the receiving tank is communicated with the cleaning tank through the first pipeline assembly, and the first filter and the first pump are provided at the midway of the first pipeline assembly.

4. The cleaning device of claim 3, wherein,
the first pipeline assembly comprises a first connecting pipe, a second connecting pipe and a third connecting pipe; and
the outlet of the receiving tank is communicated with an inlet of the first pump through the first connecting pipe, an outlet of the first pump is communicated with an inlet of the first filter through the second connecting pipe, and an outlet of the first filter is communicated with the cleaning tank through the third connecting pipe.

5. The cleaning device of claim 3, wherein the overflow port is provided at a part of a top opening of the cleaning tank which is lower than the other parts of the top opening, and the receiving tank is located right below the overflow port.

6. The cleaning device of claim 3, wherein the entirety of a top opening of the cleaning tank is used as the overflow port, and the receiving tank is provided such that it surrounds the outer periphery of the cleaning tank and is positioned below the overflow port.

7. The cleaning device of claim 2, wherein the filter system further comprises a second pipeline assembly, a second filter and a second pump; and
the outlet at the bottom of the cleaning tank is communicated with the cleaning tank through the second pipeline assembly, and the second filter and the second pump are provided at the midway of the second pipeline assembly.

8. The cleaning device of claim 7, wherein the second pipeline assembly comprises a fourth connecting pipe, a fifth connecting pipe and a sixth connecting pipe; and
an inlet of the second pump is communicated with the outlet at the bottom of the cleaning tank through the fourth connecting pipe, an outlet of the third pump is communicated with the second filter through the fifth connecting pipe, and an outlet of the second filter is communicated with the cleaning tank through the sixth connecting pipe.

9. The cleaning device of claim 1, wherein the cleaning device is an ultrasonic cleaning device.

10. The cleaning device of claim 1, wherein a drainage pipe is provided on the side wall or the bottom wall of the cleaning tank, and a control valve is provided on the drainage pipe.

11. The cleaning device of claim 1, further comprising a liquid delivery pipe with an outlet through which liquid flows into the cleaning tank.

12. The cleaning device of claim 11, further comprising a liquid delivery branch,
wherein, the liquid delivery branch is communicated with the outlet of the liquid delivery pipe, the wall of the liquid delivery branch is closely against with the top of the inner wall of the cleaning tank, the liquid delivery branch comprises liquid delivery ports communicated with the inside of the cleaning tank.

13. The cleaning device of claim 12, wherein the liquid delivery branch is arranged horizontally.

14. A cleaning device comprising a cleaning tank and a filter system,
wherein the cleaning tank comprises a funnel-shaped bottom, and an outlet is provided at the tip of the funnel-shaped bottom; and
liquid in the cleaning tank can flow via the outlet at the bottom of the cleaning tank toward the inlet of the filter system and flow back into the cleaning tank via the outlet of the filter system.
